(19) United States
(12) Patent Application Publication
(10) Pub. No.: US 2023/0091661 A1
(43) Pub. Date: Mar. 23, 2023

(54) LEARNING APPARATUS, LEARNING METHOD, AND COMPUTER-READABLE RECORDING MEDIUM

(71) Applicant: NEC Corporation, Minato-ku, Tokyo (JP)

(72) Inventors: Natsuko SUZUKI, Tokyo (JP); Yoshihiro KANNA, Tokyo (JP)

(73) Assignee: NEC Corporation, Minato-ku, Tokyo (JP)

(21) Appl. No.: 17/909,009

(22) PCT Filed: Mar. 31, 2020
(86) PCT No.: PCT/JP2020/014725

§ 371 Date: Sep. 2, 2022

(51) Int. Cl. G06V 10/774

(52) U.S. Cl. CPC G06V 10/774

(57) ABSTRACT

A learning apparatus, including: a learning unit configured to learn a parameter of a score function for two-class classification so as to maximize a Partial Area Under the Curve (pAUC), based on training data of a positive instance and a negative instance and a setting value for setting a range of the pAUC; a score calculation unit configured to calculate a score for validation data of the positive instance and the negative instance, using the score function; and an adjustment unit configured to adjust the setting value based on the score.

### TECHNICAL FIELD

The invention relates to a learning generation apparatus and a learning method for generating parameters through learning, and furthermore relates to a computer-readable recording medium having recorded thereon a program for realizing the same.

### BACKGROUND ART

In anomaly detection tasks such as image inspection, when the number of normal data is overwhelmingly smaller than the number of anomalous data, i.e., when the target of two-class classification is unbalanced data, there are methods known which perform learning to maximize the pAUC (Partial Area Under the Curve), which is an evaluation index for two-class classification.

Here, AUC (Area Under the Curve) indicates the area of a region on the horizontal axis side (the lower side) of the ROC (Receiver Operating Characteristic) curve. The ROC curve is obtained by plotting the true positive rate (the vertical axis) and the false positive rate (the horizontal axis) while varying a threshold a that determines positive instances and negative instances in the score function.

The true positive fraction/true positive rate represents the percentage of positive instances that were successfully predicted to be positive out of the actual positive instances. This is, for example, an indicator of the performance of a medical test, and is the percentage of individuals, who show the signal or disease to be detected by the test, which the test correctly determines to be positive.

The false positive fraction/false positive rate represents the percentage of negative instances that were predicted to be positive out of the actual negative instances. This is, for example, an indicator of the performance of a medical test, and is the percentage of individuals, who do not show the signal or disease to be detected by the test, which the test erroneously determines to be positive.

The pAUC is the value of the AUC when the false positive rate (ranging from 0.0 to 1.0) is set at a given setting value β, and indicates the area of the region surrounded by the ROC curve, the horizontal axis, and the vertical axis passing through the setting value β.

Currently, however, the setting value β used to limit the false positive rate is set manually in order to maximize the pAUC. Patent Document 1, which is background art, discloses a machine learning management apparatus that efficiently searches for an appropriate setting value β in machine learning. In addition, Patent Document 2 discloses maximizing the pAUC.

### LIST OF RELATED ART DOCUMENTS

### Patent Document

Patent Document 1: Japanese Patent Laid-Open Publication No. 2017-228068

Patent Document 2: Japanese Patent Laid-Open Publication No. 2017-102540

### SUMMARY OF INVENTION

### Technical Problems

However, in the techniques of Patent Documents 1 and 2, when the setting value β is set to a low false positive rate, the accuracy of the two-class classification may decrease.

An example object of the invention is to provide a learning apparatus, a learning generation method, and a computer-readable recording medium that suppresses a decrease in accuracy of the two-class classification.

### Solution to the Problems

In order to achieve the example object described above, a learning apparatus according to an example aspect of the invention includes:

a learning unit configured to learn a parameter of a score function for two-class classification so as to maximize a Partial Area Under the Curve (pAUC), based on training data of a positive instance and a negative instance and a setting value for setting a range of the pAUC;

a score calculation unit configured to calculate a score for validation data of the positive instance and the negative instance, using the score function; and

an adjustment unit configured to adjust the setting value based on the score.

Also, in order to achieve the example object described above, a learning method according to an example aspect of the invention includes:

a learning step, learning a parameter of a score function for two-class classification so as to maximize a Partial Area Under the Curve (pAUC), based on training data of a positive instance and a negative instance and a setting value for setting a range of a false positive rate of the pAUC;

a calculation step, calculating a score for validation data of the positive instance and the negative instance, using the score function; and

an adjustment step, adjusting the setting value based on the score.

Furthermore, in order to achieve the example object described above, a computer-readable recording medium according to an example aspect of the invention includes a program recorded on the computer-readable recording medium, the program including instructions that cause the computer to carry out:

a learning step, learning a parameter of a score function for two-class classification so as to maximize a Partial Area Under the Curve (pAUC), based on training data of a positive instance and a negative instance and a setting value for setting a range of a false positive rate of the pAUC;

a calculation step, calculating a score for validation data of the positive instance and the negative instance, using the score function; and

an adjustment step, adjusting the setting value based on the score.

### Advantageous Effects of the Invention

As described above, according to the invention, it is possible to suppress a decrease in the accuracy of the two-class classification.

### BRIEF DESCRIPTION OF THE DRAWINGS

FIG. 1 is a diagram illustrating an example of a learning apparatus.

FIG. 2 is a diagram illustrating an example of a system including the learning apparatus.

FIG. 3 is a diagram illustrating the adjustment of the false positive rate.

FIG. 4 is a diagram illustrating an example of operations of the learning apparatus.

FIG. 5 is a diagram illustrating an example of a computer that realizes the learning apparatus.

### EXAMPLE EMBODIMENT

An example embodiment of the invention will be described hereinafter with reference to the drawings. In the drawings described below, elements having identical or corresponding functions will be assigned the same reference signs, and redundant descriptions thereof may be omitted.

### Apparatus Configuration

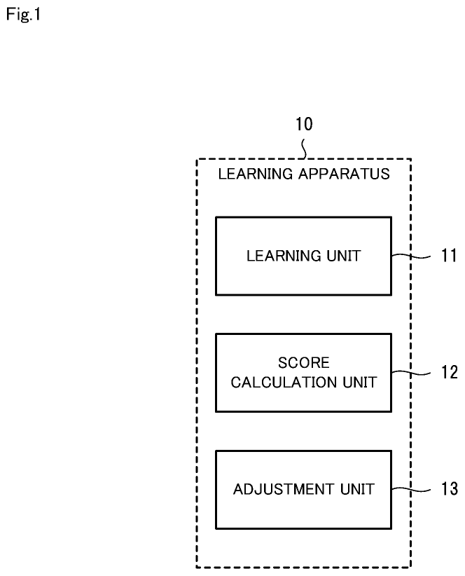

First, a learning apparatus 10 according to the example embodiment will be described with reference to FIG. 1. FIG. 1 is a diagram illustrating an example of a learning apparatus.

The learning apparatus illustrated in FIG. 1 is a device for learning parameters of a score function for two-class classification. As illustrated in FIG. 1, the learning apparatus 10 includes a learning unit 11, a score calculation unit 12, and an adjustment unit 13. A score function whose parameters have been learned is also called a trained model.

The learning unit 11 learns a parameter θ of a score function f(x;θ) for two-class classification so as to maximize the pAUC, based on training data of positive instances and negative instances and the setting value β for setting the range of the pAUC. The score calculation unit 12 uses the score function to calculate scores for validation data of the positive instances and negative instances. The adjustment unit 13 adjusts the setting value β based on the calculated score.

In the example embodiment, a drop in the accuracy of the two-class classification can be reduced by performing learning while automatically adjusting the setting value β. As a more detailed example, by initially setting the setting value β to a large value and gradually reducing the value, overlearning in the two-class classification can be suppressed, and as a result, a drop in the accuracy can be suppressed.

### System Configuration

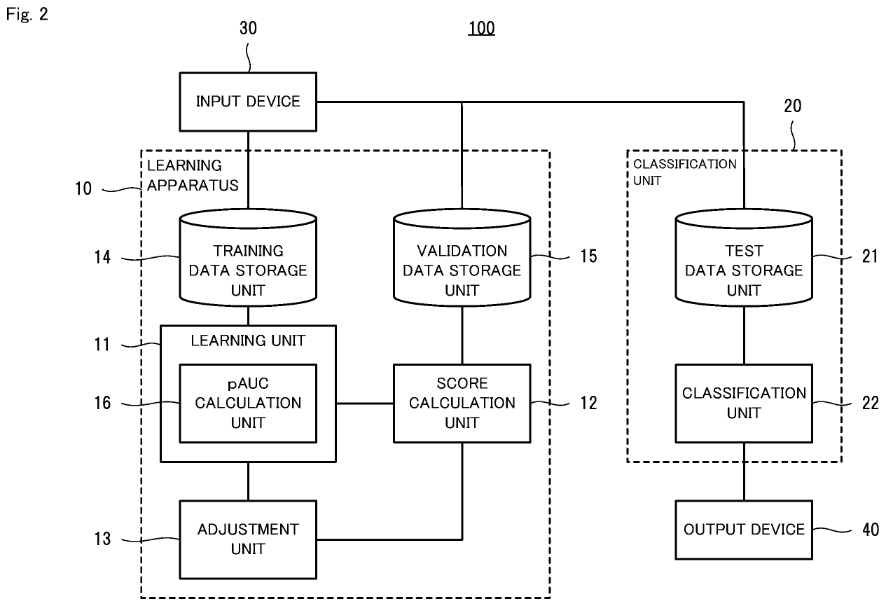

Next, the configuration of the learning apparatus 10 according to the example embodiment will be described in further detail with reference to FIG. 2. FIG. 2 is a diagram illustrating an example of a system including the learning apparatus.

A system 100 illustrated in FIG. 2 includes the learning apparatus 10, a classification apparatus 20, an input device 30, and an output device 40. The classification apparatus 20 may be configured including the learning apparatus 10.

The learning apparatus 10 includes the learning unit 11, the score calculation unit 12, the adjustment unit 13, a training data storage unit 14, and a validation data storage unit 15. The learning unit 11 also includes a pAUC calculation unit 16. Although provided outside the learning unit 11 in FIG. 2, the adjustment unit 13 may be provided within the learning unit 11.

The classification apparatus 20 calculates a score value for test data using the learned score function, learned by the learning apparatus 10, and classifies the data as a positive instance if the calculated score value is greater than a pre-set score threshold. If the calculated score value is less than or equal to the pre-set score threshold, the classification apparatus 20 classifies the data as a negative instance.

The classification apparatus 20 includes a test data storage unit 21 and a classification unit 22. Although provided inside the classification apparatus 20 in FIG. 2, the test data storage unit 21 may be provided outside the classification apparatus 20.

The input device 30 obtains training data labeled as a positive instance or a negative instance. The obtained training data is stored, for example, in the training data storage unit 14. The input device 30 also obtains validation data labeled as a positive instance or a negative instance and stores the validation data in the validation data storage unit 15. The input device 30 may obtain test data that is not labeled as a positive instance or a negative instance and store that test data in the test data storage unit 21.

The output device 40 outputs a classification result of the classification by the classification unit 22. The output device 40 is, for example, an image display device or the like that uses liquid crystals, organic EL (Electro Luminescence), or a CRT (Cathode Ray Tube). Furthermore, the image display device may include an audio output device such as a speaker or the like. The output device 40 may be a printing device such as a printer or the like.

The learning apparatus will be described next.

The training data storage unit 14 stores training data labeled as a positive instance or a negative instance. The training data is used in the learning unit 11 for learning the parameters of the score function for two-class classification. The training data is obtained through the input device 30.

The validation data storage unit 15 stores the validation data labeled as a positive instances or a negative instances, obtained from the input device 30. Validation data is used to verify the validity of the learning result. Note that in the example embodiment, the validation data is used to adjust the setting value β.

Although provided inside the learning apparatus 10 in FIG. 2, the training data storage unit 14 and the validation data storage unit 15 may be provided outside the learning apparatus 10.

The learning unit 11 learns the parameter θ of the score function f(x;θ) for two-class classification using the training data so as to maximize the pAUC. The learning unit 11 repeatedly learns the parameter θ while adjusting the setting value β.

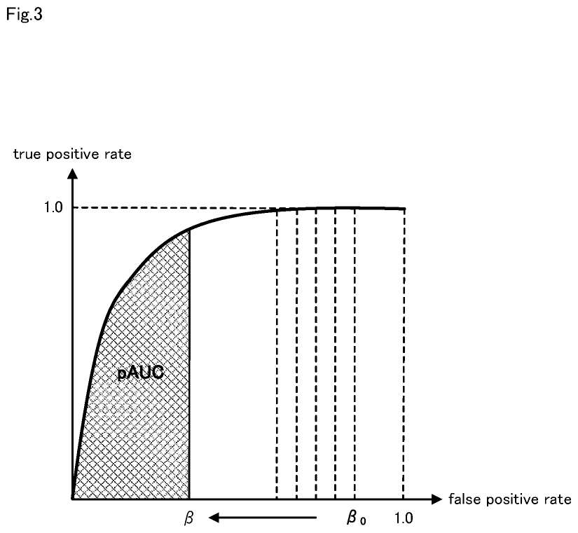

As illustrated in FIG. 3, each time the learned parameter θ is updated, the setting value β is reduced from an initial value β₀. FIG. 3 is a diagram illustrating the adjustment of the false positive rate.

Once the learning has converged sufficiently, the learning unit 11 ends the learning. If the learning has not converged sufficiently, the learning unit 11 continues the learning. The learning is determined to have converged when, for example, the result calculated by the score calculation unit 12 has not fluctuated for a set period of time compared to the beginning of the learning.

Specifically, first, when learning the parameter θ, the learning unit 11 sets the initial value β₀ as the setting value β. The initial value β₀ is, for example, set to 1.0, which is the maximum value which can be taken for the false positive rate.

Setting the initial value β₀ to a sufficiently high value and then gradually reducing that value to β makes it possible to involve a large amount of training data, including both positive instances and negative instances, in the early stages of the learning. As a result, the number of iterations required for the learning to converge can be suppressed, and the classification accuracy can be improved for cases where the false positive rate is low.

However, as long as the aforementioned effect can be achieved, the initial value β₀ may be set to a value aside from 1.0, e.g., the initial value β₀ may be set to a value close to 1.0. A false positive rate obtained through experimentation, simulations, or the like may be used as the initial value β₀.

Next, the pAUC calculation unit 16 of the learning unit 11 uses the score function f(x;θ) to calculate a score for each of the training data stored in the training data storage unit 14.

The pAUC calculation unit 16 calculates the pAUC according to Formula 1. Specifically, the pAUC calculation unit 16 sorts the negative instance training data (samples) in order of increasing score. Next, according to Formula 1, the pAUC calculation unit 16 calculates the pAUC for the entire training data included in the setting value β from the top, adding a weight of 1 if the score of negative instances is greater than the threshold α(xⱼ⁻>α), and adding a weight of 0 if the score of negative instances in other training data is less than or equal to the threshold α(xⱼ⁻≤α)(=training data not included in the setting value β).

$$pAUC ( θ ) = \frac{1}{{N}^{+} {N}^{-}} {\sum }_{i = 1}^{{N}^{+}} {\sum }_{j = 1}^{{N}^{-}} I ( f ( {x}_{i}^{+} ; θ ) > f ( {x}_{j}^{-} ; θ ) ) I ( f ( {x}_{j}^{-} > α ) \qquad [ Math . 1 ]$$

pAUC : Part of the area of the ROC
N⁺ : Samples of positive instance class of training data
N⁻ : Samples of negative instance class of training data
I( ) : A function that makes the Heaviside function (0-1 function) differentiable
f(xᵢ⁺; θ) : Score function of positive instance
f(xⱼ⁻; θ) : Score function of negative instance
Xᵢ⁺ : Score function of positive instance
Xⱼ⁻ : Score function of negative instance
α : Threshold at which the false positive rate coincides with the setting value β

Note that I( ) is a kind of function obtained by modifying the Heaviside function (0-1 function) to be differentiable, and a sigmoid function or any monotonically-increasing function may be used. In machine learning, for example, parameters are learned using the gradient descent method or the like, and because learning is not possible without differentiation, a differentiable function is used.

Next, the pAUC calculation unit 16 updates the parameter θ according to Formula 2. Specifically, the parameter θ that maximizes the pAUC for the setting value β is obtained.

$$\hat{θ} = {arg max}_{θ} pAUC ( θ , β ) \qquad [ Math . 2 ]$$

Note that in Formula 2, the gradient obtained by differentiating Formula 1 by θ is used to update θ using the mountain-climbing method in the direction that increases the objective function (Formula 1). The mountain-climbing method is a method that maximizes the objective function while searching a vicinity, of the current parameters, where the value of the objective function is greatest.

Specifically, as indicated in Formula 3, if the objective function is represented by L(θ), a small value Δθ is added to the parameter θ, and when Δθ* at which the value of the objective function is maximum is found, θ+Δθ* is taken as the new θ.

$${Δθ}^{⋆} = {arg max}_{Δθ} L ( θ + Δθ ) , θ ← θ + {Δθ}^{⋆} \qquad [ Math . 3 ]$$

Next, if the learning has converged sufficiently, the learning unit 11 ends the learning. However, if the learning has not converged sufficiently, the learning unit 11 continues the learning.

The score calculation unit 12 uses the score function f(x;θ) to calculate scores for validation data of the positive instances and negative instances. The score uses, for example, an evaluation index such as an AUC, an accuracy rate, or the like.

A case where the AUC is used as the score will be described. First, the score calculation unit 12 calculates the score, using the score function f(x;θ), based on each instance of validation data stored in the validation data storage unit 15.

Next, the score calculation unit 12 calculates the AUC according to Formula 4.

$$AUC = \frac{1}{{N}^{+} {N}^{-}} {\sum }_{i = 1}^{{N}^{+}} {\sum }_{j = 1}^{{N}^{-}} I ( f ( {x}_{i}^{+} ; θ ) > f ( {x}_{j}^{-} ; θ ) ) \qquad [ Math . 4 ]$$

AUC : Score (index) with respect to the validation data
N⁺ : Samples of positive instance class of validation data
N⁻ : Samples of negative instance class of validation data
I( ) : A function that makes the Heaviside function (0-1 function) differentiable
Xⱼ⁺ : Score function of positive instance
X_{J}⁻ : Score function of negative instance

Next, the score calculation unit 12 outputs the calculated AUC to the adjustment unit 13.

The adjustment unit 13 adjusts the setting value β based on the score with respect to the validation data. Specifically, first, the adjustment unit 13 determines whether or not the score calculated by the score calculation unit 12 is at least a pre-set threshold.

Next, if the score is at least the pre-set threshold, the adjustment unit 13 reduces the setting value β.

The threshold is determined through experimentation, simulations, or the like. Specifically, the threshold is determined according to the value of the AUC to be used as a performance target.

The interval at which the setting value β is reduced is reduced each time the learning parameter θ is updated. Additionally, the value by which the setting value β is reduced is determined through experimentation, simulations, or the like. Specifically, the value by which the setting value β is reduced may be a fixed value, or may be reduced gradually.

When a fixed value is used, the setting value β may be reduced 0.01 at a time from 1.0, for example. Additionally, the adjustment unit 13 may reduce the setting value β gradually from the initial value β₀ (=1.0), such that the false positive rate is ½, ¼, ⅛, and so on.

If the score is less than the pre-set threshold, the adjustment unit 13 fixes the setting value β. Note that after fixing the setting value β, the adjustment unit 13 uses the fixed setting value β in the subsequent learning regardless of the calculated score.

In this manner, once the setting value β has been fixed, keeping the setting value β fixed regardless of the score makes it possible to prevent a state of overlearning. This makes it possible to suppress a situation in which the learning becomes unstable at low setting values β and the accuracy of the classification drops as a result.

The classification apparatus will be described next.

The test data storage unit 21 stores test data, obtained from the input device 30 and to which positive instance or negative instance labels have not been assigned, which is used to generate the score function for the two-class classification.

The classification unit 22 calculates score values for the test data using the learned score function f(x;θ), which has been learned by the learning apparatus 10. Next, if the calculated score value is greater than the pre-set score threshold, the classification unit 22 classifies the data as a positive instance. If the calculated score value is less than or equal to the pre-set score threshold, the classification unit 22 classifies the data as a negative instance. The classification unit 22 then outputs the classification result to the output device 40.

### Apparatus Operations

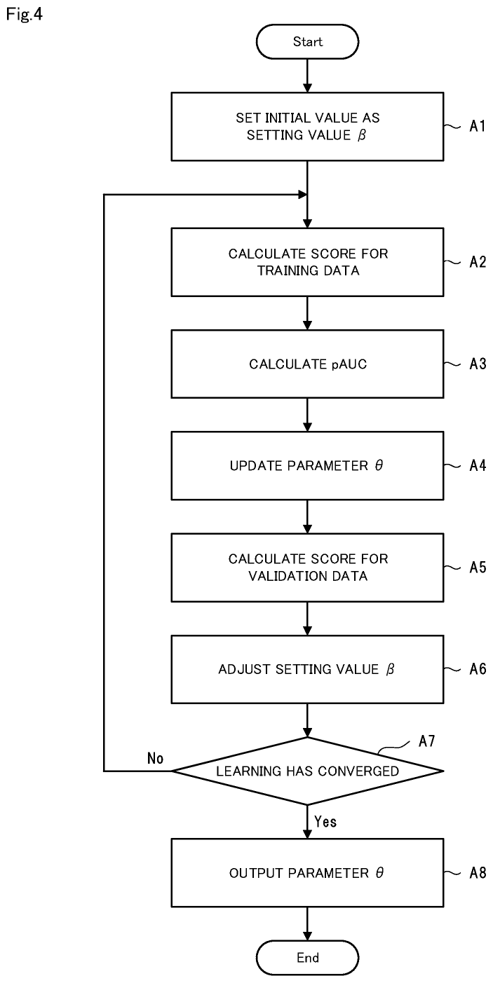

Next, operations of the learning apparatus according to the first example embodiment of the invention will be described with reference to the drawings. FIG. 4 is a diagram illustrating an example of operations of the learning apparatus. The following descriptions will refer to FIG. 1 as appropriate. In the example embodiment, a learning method is realized by causing the learning apparatus to operate. As such, the following descriptions of the operations of the learning apparatus will be given in place of descriptions of the learning method according to the example embodiment.

As described above, a score function whose parameters have been learned is also called a trained model. As such, the operations of the learning apparatus are also a trained model generation method.

As illustrated in FIG. 4, when learning the parameter θ, the learning unit 11 first sets the initial value β₀ as the setting value β (step A1).

The pAUC calculation unit 16 of the learning unit 11 uses the score function f(x;θ) to calculate a score for each of the training data stored in the training data storage unit 14 (step A2).

The pAUC calculation unit 16 calculates the pAUC according to Formula 1 (step A3). Specifically, in step A3, the pAUC calculation unit 16 sorts the negative instance training data (samples) in descending order of score, and according to Formula 1, calculates the pAUC for the training data included in the setting value β (the false positive rate) from the top, adding a weight of 1 if the score of negative instances is greater than α(xj−>α), and adding a weight of 0 if the score of negative instances in other training data is less than or equal to a (xj−≤α)(=training data not included in the setting value β).

The pAUC calculation unit 16 updates the parameter θ according to Formula 2 (step A4). Specifically, the parameter θ that maximizes the pAUC for the setting value β is obtained.

The score calculation unit 12 uses the score function f(x;θ) to calculate scores for validation data of the positive instances and negative instances (step A5). The score uses, for example, an index such as an AUC, an accuracy rate, or the like.

The adjustment unit 13 adjusts the setting value β based on the score with respect to the validation data (step A6). Specifically, in step A6, first, the adjustment unit 13 determines whether or not the score calculated by the score calculation unit 12 is at least a pre-set threshold.

Next, in step A6, if the score is at least the pre-set threshold, the adjustment unit 13 reduces the setting value β.

In step A6, if the score is less than the pre-set threshold, the adjustment unit 13 fixes the setting value β. Note that after fixing the setting value β, the adjustment unit 13 uses the fixed setting value β in the subsequent learning regardless of the calculated score.

If the learning has converged sufficiently (step A7: Yes), the learning unit 11 ends the learning and outputs the parameter θ (step A8). However, if the learning has not converged sufficiently (step A7: No), the learning unit 11 continues the learning.

### Effects of Example Embodiment

According to the example embodiment, a drop in accuracy caused by performing learning while automatically adjusting the setting value β can be suppressed.

For practical purposes, it is best for the setting value β (the false positive rate) to be set as low as possible, but if the setting value β is set too low, a state of overlearning will arise and the accuracy of the two-class classification will drop. However, according to the example embodiment, the setting value β is initially set to a high value, and learning is performed while gradually reducing the value, which makes it possible to suppress overlearning and, as a result, makes it possible to suppress a drop in the accuracy.

In addition, as described above, by setting the initial value β₀ of the setting value β to the maximum value that can be taken (a false positive rate of 1.0) and then learning while reducing the setting value β, the number of iterations (number of repetitions) required for the learning to converge can be suppressed without falling into a state of overlearning.

Furthermore, once the setting value β has been fixed, repeating the learning while keeping the setting value β fixed regardless of the score makes it possible to suppress instability in the learning.

[Program]

The program according to an embodiment of the invention may be a program that causes a computer to execute steps A1 to A8 shown in FIG. 4. By installing this program in a computer and executing the program, the learning apparatus, and the learning method according to the example embodiment can be realized. In this case, the processor of the computer performs processing to function as the learning unit 11 (includes a pAUC calculation unit 16), the score calculation unit 12, and an adjustment unit 13.

Also, the program according to the present embodiment may be executed by a computer system constructed by a plurality of computers. In this case, for example, each computer may function as any of the learning unit 11, the score calculation unit 12, and an adjustment unit 13.

[Physical Configuration]

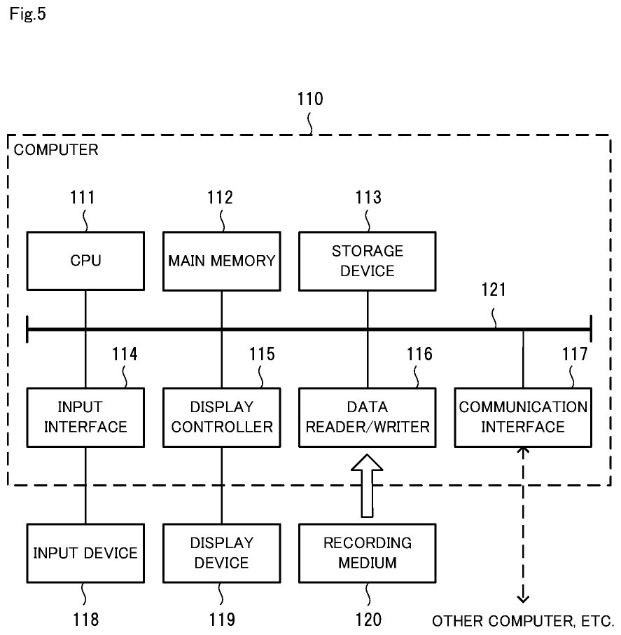

Here, a computer that realizes a learning apparatus by executing the program according to an example embodiment will be described with reference to FIG. 5. FIG. 5 is a diagram illustrating an example of a computer that realizes the learning apparatus.

As shown in FIG. 5, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117.

Also, other than a hard disk drive, a semiconductor storage device such as a flash memory can be given as a specific example of the storage device 113. The input interface 114 mediates data transmission between the CPU 111 and an input device 118, which may be a keyboard or mouse.

The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the learning apparatus 10 according to this example embodiment can also be realized by using hardware corresponding to each unit. Furthermore, a portion of the learning apparatus 10 may be realized by a program, and the remaining portion realized by hardware.

[Supplementary Notes]

Furthermore, the following supplementary notes are disclosed regarding the example embodiments described above. Some portion or all of the example embodiments described above can be realized according to (supplementary note 1) to (supplementary note 15) described below, but the below description does not limit the invention.

### (Supplementary Note 1)

A learning apparatus, including:

a learning unit configured to learn a parameter of a score function for two-class classification so as to maximize a Partial Area Under the Curve (pAUC), based on training data of a positive instance and a negative instance and a setting value for setting a range of the pAUC;

a score calculation unit configured to calculate a score for validation data of the positive instance and the negative instance, using the score function; and

an adjustment unit configured to adjust the setting value based on the score.

### (Supplementary Note 2)

The learning apparatus according to supplementary note 1,

wherein the adjustment unit reduces the setting value based on the score and takes the setting value reduced as a new setting value.

### (Supplementary Note 3)

The learning apparatus according to supplementary note 1 or 2,

wherein an initial value of the setting value is set to a false positive rate of no greater than 1.0.

### (Supplementary Note 4)

The learning apparatus according to any one of supplementary notes 1 to 3,

wherein when the score is less than the threshold, the adjustment unit fixes the setting value.

### (Supplementary Note 5)

The learning apparatus according to supplementary note 4,

wherein the learning unit learns using the setting value fixed.

### (Supplementary Note 6)

A learning method, including:

a learning step, learning a parameter of a score function for two-class classification so as to maximize a Partial Area Under the Curve (pAUC), based on training data of a positive instance and a negative instance and a setting value for setting a range of a false positive rate of the pAUC;

a calculation step, calculating a score for validation data of the positive instance and the negative instance, using the score function;

an adjustment step, adjusting the setting value based on the score; and

### (Supplementary Note 7)

The learning method according to supplementary note 6,

in the adjustment step, wherein the setting value is reduced based on the score and the setting value reduced is taken as a new setting value.

### (Supplementary Note 8)

The learning method according to supplementary note 6 or 7,

wherein an initial value of the setting value is set to a false positive rate of no greater than 1.0.

### (Supplementary Note 9)

The learning method according to any one of supplementary notes 6 to 8,

in the adjustment step, wherein when the score is less than the threshold, the setting value is fixed.

### (Supplementary Note 10)

The learning method according to supplementary note 6,

in the learning step, wherein learning is performed using the setting value fixed.

### (Supplementary Note 11)

A computer-readable recording medium that includes a program recorded thereon, the program including instructions that cause a computer to carry out:

a learning step, learning a parameter of a score function for two-class classification so as to maximize a Partial Area Under the Curve (pAUC), based on training data of a positive instance and a negative instance and a setting value for setting a range of a false positive rate of the pAUC;

a calculation step, calculating a score for validation data of the positive instance and the negative instance, using the score function; and

an adjustment step, adjusting the setting value based on the score.

### (Supplementary Note 12)

The computer-readable recording medium according to supplementary note 11,

in the adjustment step, wherein the setting value is reduced based on the score and the setting value reduced is taken as a new setting value.

### (Supplementary Note 13)

The computer-readable recording medium according to supplementary note 11 or 12,

wherein an initial value of the setting value is set to a false positive rate of no greater than 1.0.

### (Supplementary Note 14)

The computer-readable recording medium according to supplementary notes 11 to 13,

in the adjustment step, wherein when the score is less than the threshold, the setting value is fixed.

### (Supplementary Note 15)

The computer-readable recording medium according to supplementary note 11,

in the learning step, wherein learning is performed using the setting value fixed.

Although the invention of this application has been described with reference to exemplary embodiments, the invention of this application is not limited to the above exemplary embodiments. Within the scope of the invention of this application, various changes that can be understood by those skilled in the art can be made to the configuration and details of the invention of this application.

### INDUSTRIAL APPLICABILITY

As described above, according to the invention, it is possible to suppress a decrease in the accuracy of the two-class classification. The invention is useful in fields that require the two-class classification using machine learning model.

### REFERENCE SIGNS LIST

10 Learning apparatus
11 Learning unit
12 Score calculation unit
13 Adjustment unit
14 Training data storage unit
15 Validation data storage unit
16 pAUC calculation unit
20 Classification apparatus
21 Test data storage unit
22 Classification unit
30 Input device
40 Output device
100 System
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. A learning apparatus comprising:
a learning unit configured to learn a parameter of a score function for two-class classification so as to maximize a Partial Area Under the Curve (pAUC), based on training data of a positive instance and a negative instance and a setting value for setting a range of the pAUC;
a score calculation unit configured to calculate a score for validation data of the positive instance and the negative instance, using the score function; and
an adjustment unit configured to adjust the setting value based on the score.

2. The learning apparatus according to claim 1,
wherein the adjustment unit reduces the setting value based on the score and takes the setting value reduced as a new setting value.

3. The learning apparatus according to claim 1,
wherein an initial value of the setting value is set to a maximum value of a false positive rate.

4. The learning apparatus according to claim 1,
wherein when the score is less than a threshold, the adjustment unit fixes the setting value.

5. The learning apparatus according to claim 4,
wherein the learning means learns using the setting value fixed.

6. A learning method comprising:
learning a parameter of a score function for two-class classification so as to maximize a Partial Area Under the Curve (pAUC), based on training data of a positive instance and a negative instance and a setting value for setting a range of a false positive rate of the pAUC;
calculating a score for validation data of the positive instance and the negative instance, using the score function;
adjusting the setting value based on the score; and
outputting, as a trained model, the score function that has learned the parameter.

7. The learning method according to claim 6,
wherein the setting value is reduced based on the score and the setting value reduced is taken as a new setting value.

8. The learning method according to claim 6,
wherein an initial value of the setting value is set to a false positive rate of no greater than 1.0.

9. The learning method according to claim 6,
wherein when the score is less than the threshold, the setting value is fixed.

10. The learning method according to claim 9,
wherein learning is performed using the setting value fixed.

11. A non-transitory computer-readable recording medium that includes a program recorded thereon, the program including instructions that cause a computer to carry out:
learning a parameter of a score function for two-class classification so as to maximize a Partial Area Under the Curve (pAUC), based on training data of a positive instance and a negative instance and a setting value for setting a range of a false positive rate of the pAUC;
calculating a score for validation data of the positive instance and the negative instance, using the score function; and
adjusting the setting value based on the score.
